(19) United States
(12) Patent Application Publication
(10) Pub. No.: US 2005/0120060 A1
(43) Pub. Date: Jun. 2, 2005

(54) System and method for solving the dead-link problem of web pages on the Internet

(76) Inventor: Yu Meng, Bronx, NY (US)

Correspondence Address: Yu Meng, 3512 Oxford Ave, Apt 3D, Bronx, NY, 10463, US

(21) Appl. No.: 10/998,316

(22) Filed: Nov. 26, 2004

Related U.S. Application Data
(60) Provisional application No. 60/525,747, filed on Nov. 29, 2003.

(51) Int. Cl. G06F 17/30

(52) U.S. Cl. 707/202; 707/104.1; 707/204; 707/10

(57) ABSTRACT

The system and method of the invention solve the dead-link problem of web pages on the Internet. The invention records the name changes and/or path changes of web pages in a history log. When the requested web pages are available, the tracking system will not be activated at all; the requested web pages will be delivered to the users as usual. When the requested web pages cannot be found, the system will utilize the history log to locate the new locations of the requested web pages. The tracking system has a very small footprint and does not need any changes to client software or new communication protocols. Therefore, as long as the requested information is available on the web sites, no matter where the web page is, the invention is able to locate the web page and deliver the information to users.

### CROSS-REFERENCE TO RELATED APPLICATION

This application claims priority to U.S. Provisional Patent Application Ser. No. 60/525,747, filed Nov. 29, 2003.

### FEDERALLY SPONSORED RESEARCH

Not Applicable

### SEQUENCE LISTING OR PROGRAM

Not Applicable

### BACKGROUND OF THE INVENTION

This invention relates to a system and method of solving the dead-link problem of web pages on the Internet.

A dead-link is an html link that has gone bad. The destination page no longer exists. Almost all Internet users have experienced that problem: when they click a hyper-link on the Internet, they receive a message saying “The page cannot be found.” In many cases, the not-found web pages are still on the Internet, but they were renamed and/or relocated on the web server.

If you move to a new home, you do not want to lose mail sent to your old address. Usually, you will go to the post office and request that all mail addressed to you at your old address be forwarded to your new address.

Analogously, most web masters want their users to find their desired web pages that have been relocated from one location to another.

The present invention records web pages' history, so that these pages can be located by Internet users even after they are moved to a new location.

The present invention is the “post office” for web pages, in that it can forward all hits at vacated web pages' locations to their new locations on the Internet.

At this stage of the information age, the contents and the locations of web pages frequently change. Many efforts have been made to detect and/or track those changes.

Freivald et al, U.S. Pat. No. 6,012,087, provide an improved change-detection tool that periodically retrieves the web page at the specified URL and generates a checksum or signature to detect relevant changes. Their tool does not track down the web page if it is renamed or relocated.

Ball et al, U.S. Pat. No. 6,366,933, provide a system for observing a user's examination of a document contained in a repository. When the user examines the document at a later time, the invention presents the document in the current, later, form, and indicates the modifications that have occurred since the user last viewed the document. Their system does not enable the user to access the document if the document has been renamed or relocated.

Rajan et al, U.S. Pat. No. 6,633,910, provide an Internet subscription system for alerting subscribers to changes in data maintained at Internet sites. Their system, too, does not enable the user to access the document if the document has been renamed or relocated.

Pivnichny et al, U.S. Pat. No. 5,974,445, provide a web browser that checks availability of hot links on a displayed web page. But they can't recover the information of unavailable hot links.

Chen et al, U.S. Pat. No. 6,625,624, present a system and method of providing information retrieved from a server from across a communication network that enables archiving services. The network resource naming (e.g. URL) format is extended to include archive directives that are intercepted and performed by a proxy server. Their services enable users to retrieve and/or search for old information by archiving web pages, even after such information has evolved or disappeared from the original server. Their walking facility is a basic function supporting a mechanism to walk through document page hierarchies. Because their system doesn't record the history of name changes or path changes of web pages, it is impossible to locate the new location of a web page if the page has been renamed and/or relocated. Furthermore, if users don't know new locations of renamed and/or relocated web pages, they have to walk through all document page hierarchies to try to find their desired web pages. With the current invention, name and/or path changes of web pages are recorded, and users will be redirected to the new locations of web pages without having to search through all document page hierarchies manually.

Barritz, U.S. patent application Ser. No. 09/861,160, entitled “Method allowing persistent links to web-pages,” shows a method allowing persistent links to web pages. He utilizes a URL resolution database tool that contains information that enables the conversion of symbolic path information to physical path information. His method contains several problems that are absent from the present invention. First, his method cannot solve the dead-link problem. After users find their desired web pages with the URL resolution database, they will not access the symbolic paths in subsequent visits if they remember the physical paths as their links or their favorites. If, after the users' first visit, the web page has been renamed or relocated, the users get a dead-link. Barritz's invention can solve the dead-link problem only if users access symbolic paths first and never access physical paths directly. But it is impossible to ensure that users will access the symbolic path first every time. Secondly, Barritz's method has to maintain symbolic path information and physical path information for all web pages in order to find all web pages, while the present invention won't affect web pages that were not renamed or relocated. With Barritz's method, web servers interface with a URL resolution database tool that contains information that enables the conversion of the symbolic path information to physical path information. Therefore, with his system, accessing any web page requires the accessing of the URL resolution database, which will cause excessive performance overhead. With the present invention, only accessing renamed web pages or relocated web pages will require the use of the history log to recover the new locations. When users visit available web pages, they can access those pages as usual without affecting system performance. Many of the web pages on the Internet retain their original names and locations, only some web pages renamed or relocated. With Barritz's system, system performance will be affected dramatically, because the URL resolution database has to be accessed whenever users access any web page.

### BRIEF SUMMARY OF THE INVENTION

It is an object of the invention to solve the dead-link problem on web servers on the Internet when web pages have been renamed and/or relocated.

It is another object of the invention to track file name changes and/or file path changes of web pages on the Internet.

Briefly, the present invention relates to a tracking system and method for storing history information of web pages in a history log.

Changes of a web page can be recorded in several ways. For example, if web developers who maintain web pages use Microsoft Windows as their platform, file changes can be detected and recorded automatically by using FileSystemWatcher object provided in NET Framework. In this article, a graphical interface with a genetic method of recording file name changes is shown in FIG. 3.

When a user requests a web page from a web server, the web server will try to locate the requested web page in the file system on the web server. If the requested page is not found, it is probably because the requested web page has been renamed and/or relocated. In this case, the web server will send a request to the tracking system for locating the requested page. The tracking system will search the history log to find the history information of the requested web page.

If the history information can be found, the tracking system will locate the requested web page at the new location. Then the web page at the new location will be delivered to the user through the Internet.

In general, the present invention provides a tracking system and method of locating web pages when they have been renamed and/or relocated on a web server. History information of web pages is stored on web servers and used to locate web pages when the requested web pages no longer exist with their original names and/or locations.

If the present invention is used on web servers, users do not have to know anything about the tracking system. The users can use the web servers on the Internet as usual, while the tracking system will locate the web pages that have been renamed and/or relocated.

The above and other objects and advantages of the invention will become more readily apparent when reference is made to the description in conjunction with the accompanying drawings.

### BRIEF DESCRIPTION OF THE DRAWINGS

FIG. 1 is a diagram illustrating the location of the tracking system of the present invention in a typical system for the Internet.

FIG. 2 is a flow chart illustrating the operations of the tracking system.

FIG. 3 shows a graphical interface when an operator renames a web page.

FIG. 4 shows a graphical interface of a web browser that shows redirection information for a user.

FIG. 5 shows the XML source code that records history information of a web page.

### DETAILED DESCRIPTION OF THE INVENTION

Glossary of Terminology

File System

Usually, “file system” refers to a system for organizing directories and files, generally in terms of how it is implemented in the disk operating system.

As an extension of this sense, “file system” in the present invention is used to refer to the representation of the file system's organization (e.g. its file allocation table) as opposed to the actual content of the files in the file system.

Hyperlink

A reference (link) from some point in one hypertext document to (some point in) another document or another place in the same document. A browser usually displays a hyperlink in some distinguishing way, e.g. in a different color, font, or style. When the user activates the link (e.g. by clicking on it with the mouse), the browser will display the target of the link.

Footprint

Usually, “footprint” refers to the amount of disk or RAM taken up by a program or file. As an extension of this sense, “footprint” in the present invention is used to refer to extra resources and time consumed when using a system.

History Log

A database or text file that contains information about current and legacy files, such as file name, file path, modification time, etc.

Tracking System

The computer system constructed for the present invention that tracks web pages' history information

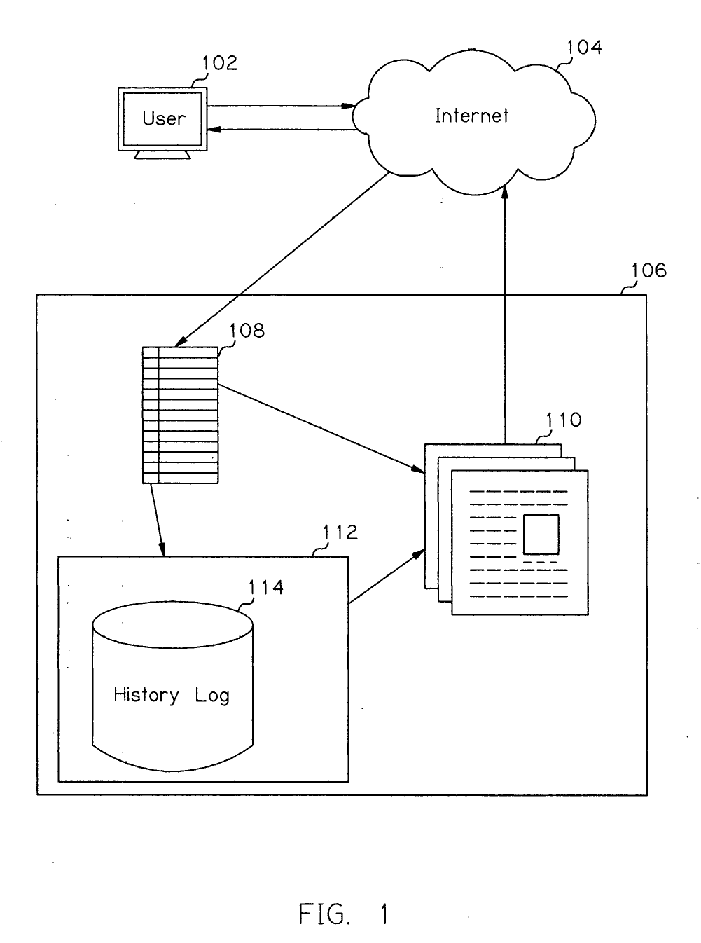

In the drawings, FIG. 1 is a diagram illustrating the location of the tracking system of the present invention in a typical system for the Internet.

As shown, a Web Server 106 communicates with User 102 via the Internet 104. The Web Server 106 includes File System 108, Web Pages 110, and Tracking System 112. The Tracking System 112 contains History Log 114.

When the User 102 requests a web page from the Web Server 106 via the Internet 104, the Web Server 106 will try to locate the requested web page in the File System 108. If the requested web page cannot be found in the File System 108, the Tracking System 112 will be activated and search the History Log 114 to search for the history information of the requested web page. The history information contains the new name and/or new location of web pages. If the new location can be found successfully, the Web Server 106 will deliver the web page at the new location to the User 102 through the Internet 104.

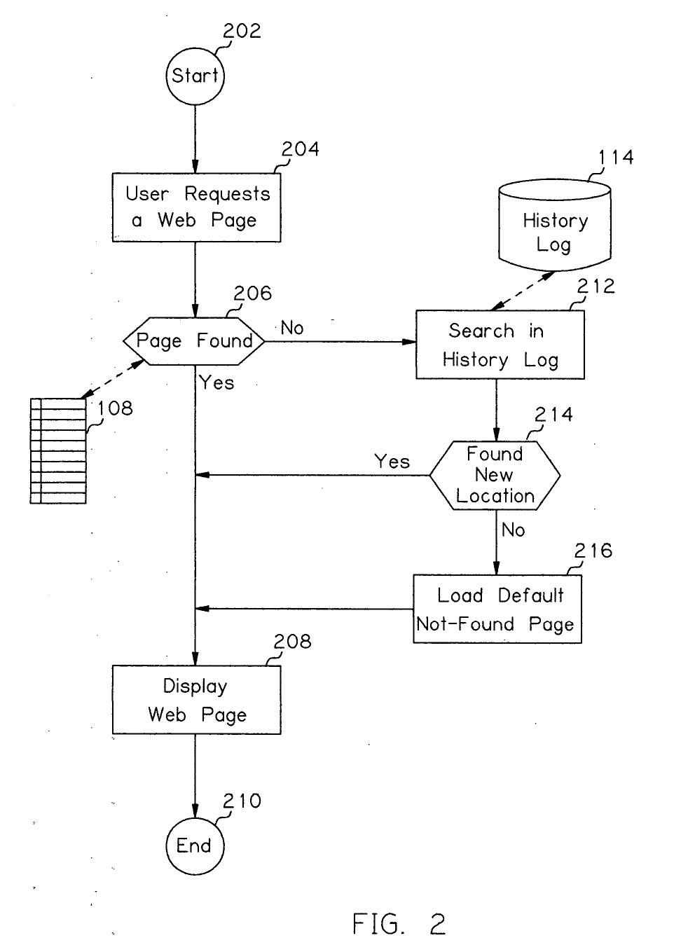

FIG. 2 is a flow chart illustrating the operations of the tracking system.

Processing begins at Start block 202.

A user requires a web page at block 204.

At decision block 206, the Web Server 106 determines whether the requested web page can be found in the File System 108. If the web page can be found, the Web Server 106 displays the web page at block 208 and the process stops at End block 210.

If the requested web page cannot be found in the File System 108, the Tracking System 112 will be activated and search the History Log 114 at block 212.

If the history information of the requested web page can be found, the Web Server 106 will locate the new name and/or new location of the web page and display the web page at block 208.

If the history information of the requested web page cannot be found, the Web Server 106 will load default not-found page at block 216 and display it at block 208.

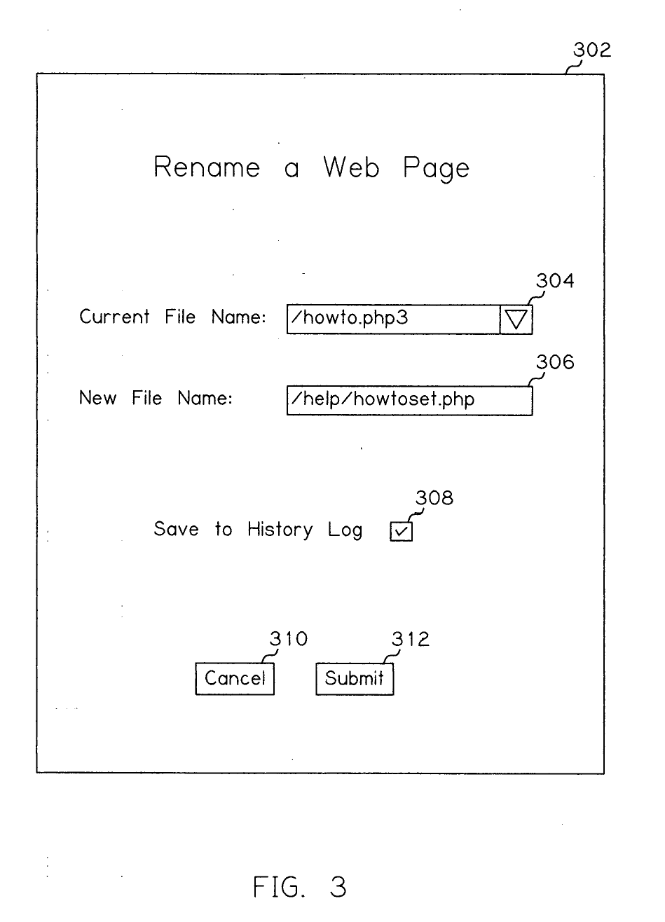

FIG. 3 shows a graphical interface when an operator renames a web page.

The operator renames a web page with the graphical interface shown in area 302.

The operator may choose a file in Current File Name box 304. Then the operator may input a new file path and a new file name in New File Name box 306.

If the operator checks “Save to History Log” check box 308 and presses Submit button 312, the file will be renamed and the changes will be saved into the History Log 114.

The history information that is saved in History Log 114 will be used to locate web pages by the Tracking System 112.

The History Log 114 will be used to locate the new location of the web page if the old filename is requested in the future.

If the operator presses Cancel button 310, no change will be made.

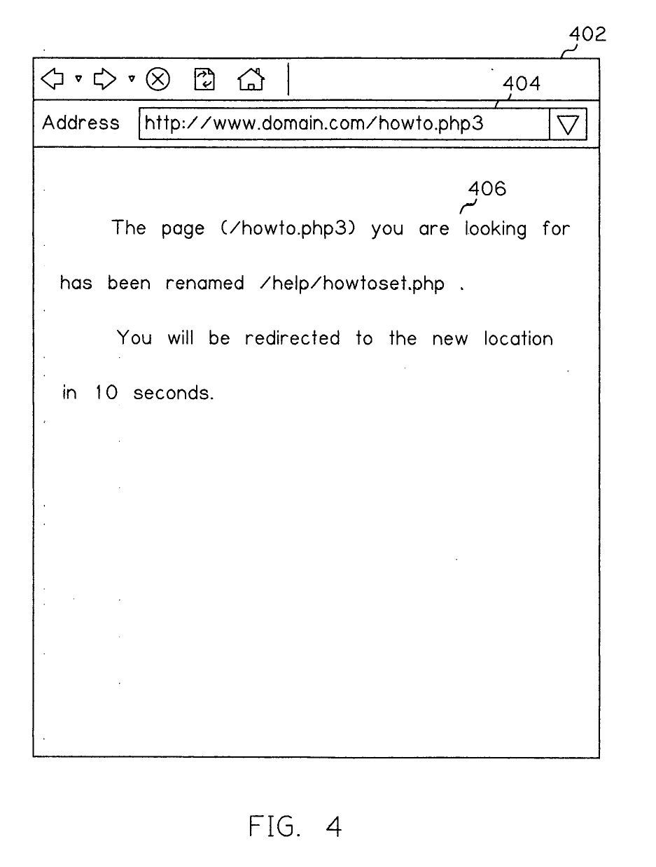

FIG. 4 shows a graphical interface of a web browser that shows redirection information for a user.

When a web page requested by a User 102 has been renamed and/or relocated, the User 102 will get relevant information in the web browser shown in area 402.

The User 102 requested “http://www.domain.com/howto.php3” at Address box 404.

The requested web page “/howto.php3” could not be found in the File System 108 on the web server provided by www.domain.com.

The Tracking System 112 running on www.domain.com searches for the history information of the web page “/howto.php3” in the History Log 114.

In this example, the Tracking System 112 found the history information of “/howto.php3”; the history information indicates that requested web page “/howto.php3” has been relocated to “/help/howtoset.php”.

The Web Server 106 displays the above information in area 406 and redirects the User 102 to the new location.

Without the Tracking System 112, the User 102 would not find the requested web page if the requested web page has been renamed and/or relocated. With the Tracking System 112, the User 102 is able to find desired information easily.

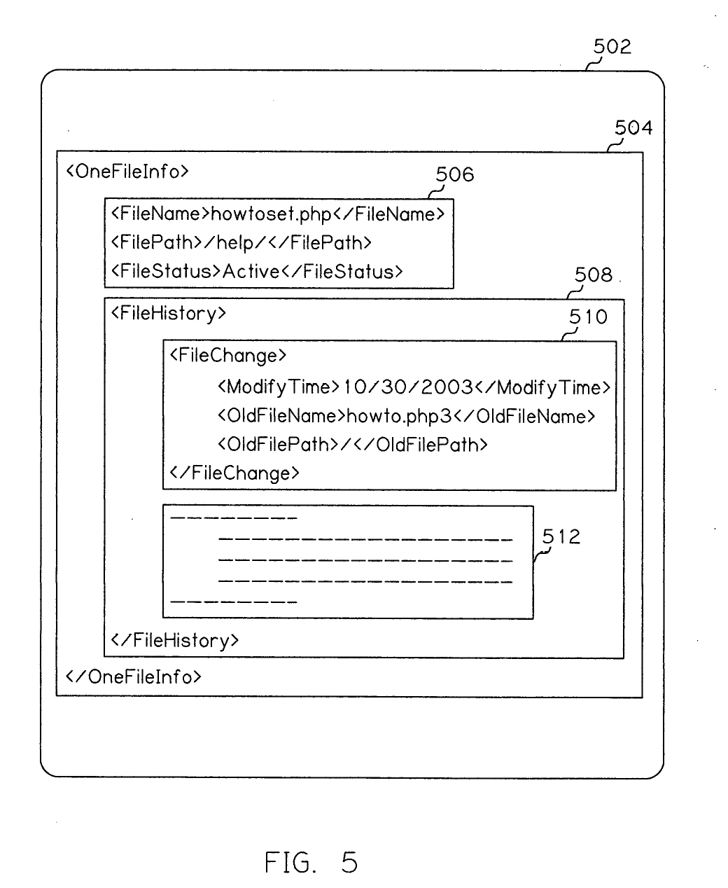

FIG. 5 shows the XML source code that records history information of a web page.

An example of an XML source code that saved information in the History Log 114 is shown in area 502.

The history information of a web page is recorded within the “OneFileInfo” tag in area 504.

It includes current file information in block 506 and legacy file information in block 508.

The current file information shown in block 506 includes file name, file path, and file status.

The file status in this example is “Active” in block 506. The file status might be “Deleted”, if the file has been deleted from the Web Server 106.

The legacy file information shown in block 508 may include one or more file changes shown in block 510 and block 512.

One file change shown in block 510 includes modification time, old file name, and old file path.

In this example, FIG. 5 indicates that file “howto.php3” was renamed “howtoset.php” and relocated from root directory “/” to directory “/help/” on Oct. 30, 2003.

Advantages

From the description above, a number of advantages of the present invention become evident:
(a) By recording the history of web pages, it solves the dead-link problem when web pages have been renamed and/or relocated.
(b) It has a very small footprint. When the target of a hyperlink exists, the present invention will not be activated at all. When the target of the hyperlink does not exist, the present invention will be activated and locate the new location of the web page for the user.
(c) It does not require changes to client software or communication protocols.
(d) As an additional benefit, the present invention can store the history of web pages and provide more information about the web sites for their administrators.
   Conclusion and Scope

Accordingly, readers can see that the present invention can solve the dead-link problem that arises because of changes in the file names and/or file paths of web pages on web servers. The present invention has a very small footprint on web servers. Moreover, the present invention can be used to record and/or track web pages' changes.

Although the present invention has been described in detail, it will be understood that this description is not intended to limit the invention to this embodiment. Instead, it is intended to cover all alternatives, modifications, and equivalents as may be included within the spirit and scope of the present invention as defined by the appended claims.

1. An Internet-based tracking system for solving dead-link problem by tracking the file name and/or file path changes of web pages stored on the Internet, comprising:
a history log storing web pages' history information; and
means for locating no-longer-existing web pages utilizing said history information; and
means for redirecting users to the new locations of said no-longer-existing web pages.

2. The tracking system as set forth in claim 1 wherein said history log refers to the group consisting of:
a text file,
database.

3. The tracking system as set forth in claim 1 wherein said web pages' history information contains data selected from the group consisting of:
file name,
file path,
creation time,
modification time,
deletion time.

4. The tracking system as set forth in claim 1 wherein said means for locating no-longer-existing web pages utilizing said history information, comprising:
means for searching said history log when requested web pages do not exist;
means for extracting said history information of said requested web pages.

5. An Internet-based tracking method for solving the dead-link problem by tracking the file name and/or file path changes of web pages stored on the Internet, comprising the steps of:
storing web pages' history information in a history log; and
locating no-longer-existing web pages utilizing said history information; and
redirecting users to the new locations of said no-longer-existing web pages.

6. The tracking method as set forth in claim 5 wherein said history log refers to the group consisting of:
a text file,
database.

7. The tracking method as set forth in claim 5 wherein said web pages' history information contains data selected from the group consisting of:
file name,
file path,
creation time,
modification time,
deletion time.

8. The tracking method as set forth in claim 5 wherein said locating no-longer-existing web pages utilizing said history information, comprising the steps of:
searching said history log when requested web pages do not exist;
extracting said history information of said requested web pages.
